(19) United States
(12) Patent Application Publication
(10) Pub. No.: US 2020/0393831 A1
(43) Pub. Date: Dec. 17, 2020

(54) METHOD OF IDENTIFYING DRIVING SPACE USING ARTIFICIAL INTELLIGENCE, AND LEARNING MODULE AND ROBOT IMPLEMENTING SAME

(71) Applicant: LG ELECTRONICS INC., Seoul (KR)

(72) Inventors: Joohan KIM, Seoul (KR); Jaecheon SA, Seoul (KR); Sunryang KIM, Seoul (KR); Yoonsik KIM, Seoul (KR)

(73) Assignee: LG ELECTRONICS INC., Seoul (KR)

(21) Appl. No.: 16/489,980

(22) PCT Filed: May 2, 2019
(86) PCT No.: PCT/KR2019/005288

§ 371 Date: Aug. 29, 2019

(51) Int. Cl. G05D 1/00; G05D 1/02

(52) U.S. Cl. CPC G05D 1/0088; G05D 1/0221; G05D 1/0238; G05D 1/027; G05D 1/0274; G05D 1/0223

(57) ABSTRACT

Disclosed herein are a method of identifying a driving space using artificial intelligence, and a learning module and a robot implementing the same, and the robot according to an embodiment identifies a space in which the robot is moving by extracting feature data from data sensed by a vibration sensor and by comparing the feature data and parameters, and controls directions or speeds of movements of a moving unit to fit for the identified space, or changes magnitude of electric energy supplied to the moving unit.

### TECHNICAL FIELD

The present disclosure relates to a method of identifying a driving space using artificial intelligence, and a learning module and a cart robot implementing the same.

### BACKGROUND

A large-scale retail store, a department store, an airport, a golf course, and the like, are places where exchange of goods and services takes place between people. People carry a variety of goods in the places. Accordingly, a device such as a cart is useful for people to carry their goods in the places.

Conventionally, users directly move carts. However, there are times when the carts are left in the middle of aisles in the above-described spaces. In this case, it requires time and effort to control each of the carts.

Accordingly, there is a growing need for a cart capable of following a user without being controlled by the user such that the user feels free to move and perform various activities. In this case, the cart is in an autonomous mode. Additionally, devices such as a cart may move using electric energy according to control by a user. In this case, the cart is in a semi-autonomous mode. However, road surfaces, on which the cart is moving in the autonomous mode or in the semi-autonomous mode, are not the same.

When moving in a space such as a parking lot in which vehicles usually move, a cart robot may confirm a difference in the road surfaces of a store and the parking lot using artificial intelligence, and may identify the space on the basis of the difference.

### DISCLOSURE

### Technical Problems

One objective of the present disclosure is to allow a cart robot to identify a space using a difference in road surfaces.

Another objective of the present disclosure is to allow a cart robot to adaptably move on road surfaces of spaces and to perform seamless driving.

Yet another objective of the present disclosure is to allow a cart robot to move on the basis of control by a user and increase safety when the robot moves in different spaces.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

### Technical Solutions

A cart robot, which is capable of identifying a driving space using artificial intelligence, according to an embodiment identifies a space in which the cart robot is moving, by extracting feature data from data sensed by a vibration sensor and by comparing the feature data and parameters, and controls directions or speeds of movements of a moving unit of the cart robot to fit for the identified space, or changes magnitude of electric energy supplied to the moving unit.

In the cart robot, which is capable of identifying a driving space using artificial intelligence, according to an embodiment, a load cell of a force sensor sensing a change in force applied to a handle assembly, senses vibrations.

The cart robot, which is capable of identifying a driving space using artificial intelligence, according to an embodiment controls PID values of a motor supplying electric energy to the moving unit of the cart robot on the basis of results of identifying a space.

In the cart robot, which is capable of identifying a driving space using artificial intelligence, according to an embodiment, a vibration sensor includes a first vibration sensor including a load cell, and a second vibration sensor including an IMU sensor, and the cart robot generates first feature data by buffering signals of the first vibration sensor, and then when the cart robot may not identify a space in which the cart robot is moving, generates second feature data by buffering signals of the second vibration sensor, and then identifies a space in which the cart robot is moving.

The cart robot, which is capable of identifying a driving space using artificial intelligence, according to an embodiment further includes an obstacle sensor sensing obstacles around the cart robot, and controls the obstacle sensor to fit for an identified space such that the obstacle sensor may sense any one or more of an object, or a human body more accurately.

A learning module, which is capable of identifying a driving space using artificial intelligence, according to an embodiment includes a storage unit that stores first data sensed by the vibration sensor of the cart robot while the cart robot is moving in a first space and that stores second data sensed by the vibration sensor of the cart robot while the cart robot is moving in a second space, and a learning unit that generates parameters identifying a plurality of first data as the first space and identifying a plurality of second data as the second space by classifying the plurality of first data and the plurality of second data stored in the storage unit.

A method of identifying a driving space using artificial intelligence by a cart robot according to an embodiment includes moving a cart robot by a moving unit of the cart robot, sensing vibrations generated while the cart robot is moving by a vibration sensor of the cart robot, extracting feature data from data sensed by the vibration sensor by a control unit of the cart robot, identifying a space in which the cart robot is moving by comparing the feature data and parameters by the control unit, and controlling directions or speeds of movements of the moving unit to fit for the identified space by the control unit or changing magnitude of electric energy supplied to the moving unit by the control unit.

### Advantageous Effects

The cart robot may confirm a change in road surfaces using a vibration sensor, thereby confirming a difference in spaces.

The cart robot may move adaptably in an identified space by identifying a change in spaces, thereby enhancing efficiency of movements.

The cart robot may move according to control by a user and may move with a high level of safety even in different driving spaces.

Effects of the present disclosure are not limited to the above-described ones, and one having ordinary skill in the art to which the disclosure pertains may easily draw various effects from the configuration of the disclosure.

### DESCRIPTION OF THE DRAWINGS

FIG. 1 shows an appearance of a cart robot according to an embodiment of the present invention.

FIG. 2 shows components of a control module of a cart robot according to an embodiment of the present invention.

FIG. 3 shows a process in which a cart robot collects data while moving in a space according to an embodiment of the present invention.

FIG. 4 shows a process in which a cart robot performs learning on collected data according to an embodiment of the present invention.

FIG. 5 shows a process in which a cart robot classifies spaces according to an embodiment of the present invention.

FIG. 6 shows signals sensed by a vibration sensor in LAND1/LAND2 according to an embodiment of the present invention.

FIG. 7 shows a feature map that displays values sensed by a vibration sensor according to an embodiment of the present invention.

FIG. 8 shows a process in which a cart robot 100 distinguishes two spaces using a load cell 245 and an IMU sensor 247.

FIG. 9 shows a configuration of a server according to an embodiment of the present invention.

FIG. 10 shows a configuration of a learning module according to an embodiment of the present invention.

FIGS. 11 and 12 show a configuration of adjusting sensing features of an obstacle sensor according to an embodiment of the present invention.

FIG. 13 shows a rear of the cart robot in FIG. 1 as an embodiment.

FIG. 14 shows an enlarged handle assembly.

FIG. 15 shows a rear perspective view of a rear of cart according to another embodiment of the present invention.

FIGS. 16 and 17 show enlarged main parts of the handle assembly in FIG. 15.

### DETAILED DESCRIPTION

Hereinafter, embodiments of the present disclosure will be described in detail with reference to the drawings so that those skilled in the art to which the present disclosure pertains can easily implement the present disclosure. The present disclosure may be implemented in many different manners and is not limited to the embodiments described herein.

In order to clearly illustrate the present disclosure, technical explanation that is not directly related to the present disclosure may be omitted, and same or similar components are denoted by a same reference numeral throughout the specification. Further, some embodiments of the present disclosure will be described in detail with reference to the drawings. In adding reference numerals to components of each drawing, the same components may have the same reference numeral as possible even if they are displayed on different drawings. Further, in describing the present disclosure, a detailed description of related known configurations and functions will be omitted when it is determined that it may obscure the gist of the present disclosure.

In describing components of the present disclosure, it is possible to use the terms such as first, second, A, B, (a), and (b), etc. These terms are only intended to distinguish a component from another component, and a nature, an order, a sequence, or the number of the corresponding components is not limited by that term. When a component is described as being “connected,” “coupled” or “connected” to another component, the component may be directly connected or able to be connected to the other component; however, it is also to be understood that an additional component may be “interposed” between the two components, or the two components may be “connected,” “coupled” or “connected” through an additional component.

Further, with respect to embodiments of the present disclosure, for convenience of explanation, the present disclosure may be described by subdividing an individual component, but the components of the present disclosure may be implemented within a device or a module, or a component of the present disclosure may be implemented by being divided into a plurality of devices or modules.

In this specification, devices, which autonomously move following a user or move using electric energy on the basis of control of a user, are referred to as a smart cart robot, a cart robot, a robot or, for short, a cart. Cart robots may be used in a large-scale retail store, a department store and the like. They may also be used in places such as an airport or a port where a large number of tourists visit. Further, they may be used in leisure spaces such as a golf course.

Additionally, the cart robot includes all types of devices that follows a user by tracking the location of the user and that has a predetermined storage space. The cart robot includes all types of devices that move using electric power according to control such as a pushing action, pulling action, and the like of a user. As a result, the user may move the cart robot without controlling the cart robot, and may move the cart robot with a small amount of force.

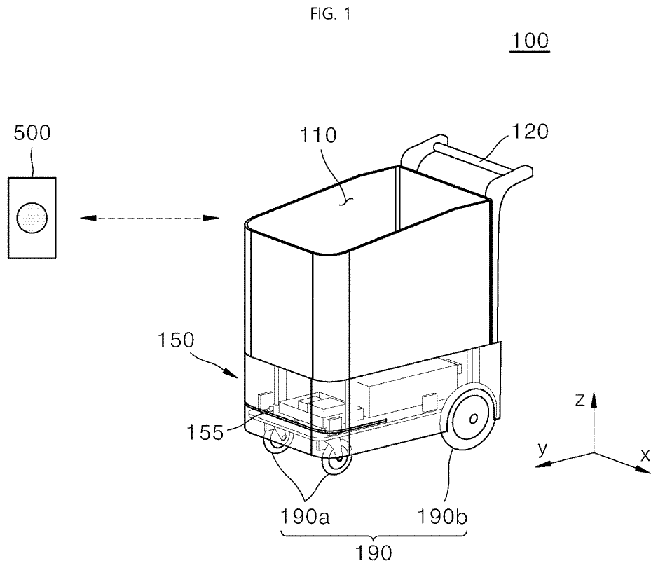

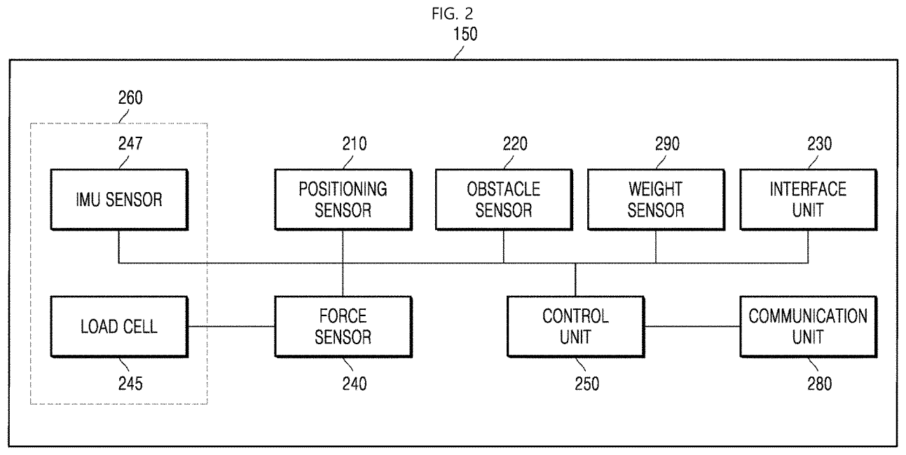

FIG. 1 shows an appearance of a cart robot according to an embodiment, and FIG. 2 shows components of a control module 150 of a cart robot according to an embodiment. The x-axis, the y-axis, and the z-axis in FIG. 1 illustrate a three-dimensional axis with respect to a cart robot.

The cart robot 100 includes a storage part 110, a handle assembly 120, a control module 150, a moving unit 190a, 190b. The storage part 110 is a space in which a user stores or piles objects. The handle assembly 120 allows a user to control movements of the cart robot 100 manually or semi-automatically.

The user may push or pull the cart robot 100, or may change a direction of the cart robot 100, using the handle assembly 120. In this case, the cart robot 100 may move semi-automatically using electric energy on the basis of the magnitude of force applied to the handle assembly 120 or on the basis of a difference in forces applied to the left and right of the handle assembly 120.

The control module 150 controls movements of the cart robot 100. Specifically, the control module 150 controls autonomous driving of the cart robot 100 such that the cart robot 100 may follow the user. Additionally, the control module 150 may control semi-autonomous driving (power assist) of the cart robot by assisting force of the user when the user pushes or pulls the cart robot using a small amount of force.

The control module 150 may control the moving unit 190. The moving unit 190 moves the cart robot along a moving path generated by the control unit 250 or on the basis of control by the control unit 250. The moving unit 190 may move the cart robot by rotating wheels that constitute the moving unit 190.

The movements of the cart robot performed by the moving unit 190 are based on rotation speeds, rotation frequencies, directions of rotation and the like of the wheels, and the control unit 250 may confirm the location of the cart robot 100. The moving path generated by the control unit 250 includes angular velocity applied to the left wheel and the right wheel of the cart robot.

Additionally, positioning sensors for following a user may be disposed in various parts of the cart robot 100 to track the location of the user. Obstacle sensors for sensing surrounding obstacles may also be disposed in various parts of the cart robot 100. See FIG. 2.

FIG. 2 shows logical components constituting the control module 150 such as a positioning sensor 210, a force sensor 240, an obstacle sensor 220, an interface unit 230, a control unit 250, a communication unit 280, and a weight sensor 290.

The obstacle sensor 220 senses obstacles disposed around the cart robot. The obstacle sensor 220 may sense a distance between the cart robot and a human, a wall, an object, a fixed object, or an installed object and the like. And the obstacle sensor 220 may record images of an object/a human/an installed object and the like around the cart robot. The obstacle sensor 220 may be disposed at the lower end of the cart robot 100.

For example, a plurality of obstacle sensors 220 are disposed in an area indicated by reference numeral 155. The plurality of obstacle sensors 220 may sense obstacles at the front side/left side/right side/rear side of the cart robot. The obstacle sensor 220 may be disposed at the same height at the lower end of the cart robot 100.

Additionally, two or more obstacle sensors 220 may be disposed in parts of different height at the lower end of the cart robot 100. Further, the obstacle sensor 220 may be disposed on the front surface/both lateral surfaces of the cart robot in a direction in which the cart robot 100 moves. When the cart robot 100 moves backward, the obstacle sensor may be disposed on the front surface, the rear surface, both of the lateral surfaces of the cart robot.

The weight sensor 290 senses weight of objects piled in the storage part 110 of the cart robot.

The positioning sensor 210 is a component of the cart robot, which assists autonomous driving. In the case of a cart robot that assists only semi-autonomous driving (power assist), the positioning sensor 210 may be optionally provided.

The positioning sensor 210 may track the location of a user having a transmitting module 500, and may be disposed at the upper end, on a lateral surface and the like of the cart robot 100. However, the locations of the sensors may vary depending on embodiments, and the present disclosure is not limited to what has been described. Additionally, regardless of the locations of the sensors, the control module 150 controls the sensors or uses information sensed by the sensors. That is, the sensors are logical components of the control module 150 regardless of their physical locations.

The positioning sensor 210 receives signals from the transmitting module 500 and measures the location of the transmitting module 500. The user may possess the transmitting module 500 that transmits predetermined signals to the positioning sensor 210. As an example, the positioning sensor 210 may receive signals from the transmitting module 500 using UWB (Ultra-wideband).

Additionally, the positioning sensor 210 may confirm the location of the user on the basis of the location of the transmitting module 500. As an example, the user may possess a transmitting module 500 in the form of a band that is attached to the wrist of the user.

The interface unit may be disposed in the handle assembly 120 to output predetermined information to the user, and the interface unit may also be a component controlled by the control module 150. The handle assembly 120 includes a force sensor 240 that senses forces applied by the user of pushing or pulling the cart robot, i.e., forces applied to the handle assembly 120. The interface unit may be disposed optionally in various locations.

The force sensor 240 may be disposed outside or inside the cart robot 100 to which different magnitudes of forces are applied by manipulation of the handle assembly 120. The location or the configuration of the force sensor 240 may vary. Embodiments of the present disclosure are not limited to a specific force sensor 240.

The force sensor 240 may be disposed in the handle assembly 120 or may be disposed outside or inside the cart robot 100 connected to the handle assembly 120. The force sensor 240 senses magnitudes, changes and the like of forces when the user applies force to the handle assembly 120. The force sensor 240 includes various sensors such as a hall sensor, a magnet-type sensor, a button-type sensor, a load cell and the like. The force sensor 240 is comprised of a left force sensor and a right force sensor, and the left force sensor and the right force sensor may be respectively disposed in the handle assembly 120 or inside or outside of the cart robot 100.

When the force sensor 240 includes one or more load cells 245 or when one or more load cells 245 are used to implement the force sensor 240, the load cell 245 may sense vibrations caused by friction of the cart robot against the ground while the cart robot is moving.

The load cell 245 is mounted onto the cart robot 100 to convert the force applied to the handle assembly 120 into electric signals. The load cell 245 senses the pushing force, the pulling force and the like applied by the user to the cart robot 100.

Additionally, the load cell 245 senses vibrations caused by friction of the cart robot 100 against the ground while the cart robot 100 is moving. The load cell 245 generates signals in relation to vibrations. Accordingly, the control unit 250 may confirm the state of a road surface on the basis of vibrations caused by the road surface, which are sensed by the load cell 245.

An additional IMU (inertial measurement unit) sensor 247 may be disposed in the cart robot 100. As an example, the IMU sensor 247 may be disposed near the moving unit (190a, 190b).

The above-described load cell 245 and the IMU sensor 247 may be optionally disposed in the cart robot 100 or may all be disposed in the cart robot 100 to sense vibrations generated according to the state of a driving surface on which the cart robot 100 is moving.

The IMU sensor 247 measures acceleration and gyro, and Earth's magnetic field. The IMU sensor senses signals required for confirming whether the cart robot 100 tilts or vibrations are generated among the components of the cart robot 100. Additionally, the IMU sensor 247 senses whether the driving surface on which the cart robot is moving is altered.

Accordingly, the load cell 245 and the IMU sensor 247 may respectively sense forces applied to the handle assembly 120 or may measure an acceleration, a gradient and the like of the cart robot 100, and at the same time, may sense vibrations generated in the cart robot 100.

Hereinafter, the load cell 245 and the IMU sensor 247 are all referred to as a vibration sensor 260. The vibration sensor 260 senses vibrations caused by friction of the cart robot against a road surface and the like while the cart robot is moving, using any one or more of the load cells 245 and the IMU sensors 247. The vibration sensor 260 may sense changes in the x/y/z-axes, which are generated while the cart robot 100 in FIG. 1 is vibrating.

The obstacle sensor 220 senses an obstacle disposed around the cart robot. The obstacle sensor 220 includes a sensor that measures a distance, or acquires an image and confirms an obstacle in the image. In an embodiment, the obstacle sensor 220 for measuring a distance is an infrared sensor, an ultrasonic sensor, a radar sensor and the like.

Additionally, the obstacle sensor 220 includes a depth sensor or an RGB sensor. The RGB sensor may sense an obstacle and an installed object in an image. The depth sensor generates information on depth at each point in an image.

Further, the obstacle sensor 220 includes a time of flight (TOF) sensor.

The control unit 250 accumulates and stores location information on the transmitting module, and generates a moving path corresponding to the stored location information on the transmitting module. To accumulate and store location information, the control unit 250 may store location information on the transmitting module 500 and the cart robot 100 as absolute location information (absolute coordinate) that is based on a certain reference point.

Additionally, the control unit 250 may control movements of the cart robot by confirming whether there is a change in a driving surface using the obstacle sensor 220 and the vibration sensor 260

Further, the control unit 250 may control directions or speeds of the movements of the moving unit on the basis of changes in forces or magnitudes of forces sensed by the force sensor 240, or may control the moving unit 190 such that more electric energy is supplied to a motor of the moving unit to control the speeds of movements of the moving unit.

When the control unit 250 distinguishes changes in a road surface and a space on the basis of sensing of the vibration sensor 260 in the process during which the cart robot performs autonomous driving or semi-autonomous driving (power assist mode), the control unit 250 may control the moving unit 190a, 190b according to characteristics of the road surface.

For example, when materials of the road surfaces of a store and a parking space are different, the control unit 250 may control movements of the cart robot according to characteristics of each of the identified spaces.

For example, when confirming that the cart robot 100 is moving in a parking space, using the vibration sensor 260, the control unit 250 may control the obstacle sensor 220 or the moving unit 190 such that the cart robot 100 recognizes a moving vehicle or a parked vehicle first.

Additionally, when confirming that the cart robot 100 is moving in a regular space (e.g., a retail store and the like), using the vibration sensor 260, the control unit 250 may control the obstacle sensor 220 or the moving unit 190 to prevent the cart robot 100 from bumping against a pedestrian.

When a high level of vibration is sensed by the vibration sensor 260 or when the cart robot 100 moves on a road surface that generates a high level of friction, the control unit 250 may control the speed and torque of the motor of the moving unit 190. Specifically, when the cart robot moves on the road surface of a space such as a parking space, which has a high level of friction, the control unit 250 may change a maximum torque of the motor to allow the cart robot 100 to easily move.

Additionally, when the load cell 245 that is a component of the force sensor 240 for semi-autonomous driving (power assist mode) is used as the vibration sensor 260, a single sensor may perform all the functions of sensing forces and road surfaces, thereby reducing manufacturing costs.

In summary, the control unit 250 extracts feature data from data sensed by the vibration sensor 250 and compares the feature data and pre-stored parameters. Additionally, the control unit 250 identifies a space in which the cart robot 100 is moving, and according to the identified space, controls directions or speeds of movements of the moving unit 190 or changes magnitude of electric energy supplied to the moving unit 190. In this process, the control unit 250 identifies a space in which the cart robot is currently moving, and according to the space, controls the moving unit 190, using data sensed by the vibration sensor 260.

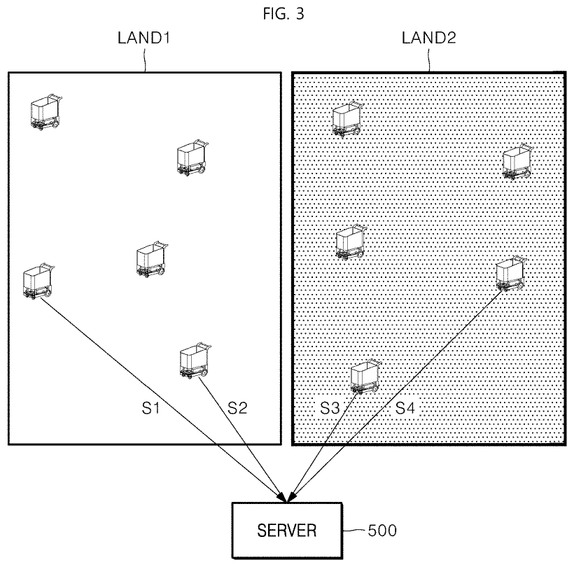

The communication unit 280 may be optionally disposed in the cart robot 100. As illustrated in FIG. 3, some of the cart robots include a communication unit 280. The communication unit 280 transmits data sensed by the vibration sensor 260 to the server 500, and receives parameters required for distinguishing spaces from the server 500.

FIG. 3 shows a process in which a cart robot according to an embodiment collects data while moving in a space. In FIG. 3, some of the cart robots transmit collected data to the server 500 (S1˜S4). In this case, the cart robots do not include a learning module for performing learning.

When the control unit includes a learning module, the cart robots perform learning directly using collected data.

FIG. 3 shows two spaces (LAND1, LAND2) in which the cart robots 100 may move. For example, LAND1 is a regular store having smooth ground, and LAND2 is a parking space having rough ground. Vibrations delivered from the road surfaces to the cart robots 100 are recorded while a plurality of cart robots 100 are moving in the two spaces.

Vibrations that are delivered to the cart robots 100 when the cart robots 100 move on LAND1 having smooth ground have different properties from vibrations that are caused by friction of the cart robots 100 against the road surface when the cart robots 100 move on LAND2 having rough ground. Vibrations vary depending on characteristics of road surfaces.

The vibration sensor 260 of the cart robot 100 senses vibrations that are generated while the cart robot 100 is moving, and the control unit 250 stores the sensed vibrations as various feature data. Examples of the feature data include data such as values of horizontal widths of sensed vibrations, values of vertical range of sensed vibrations, time periods during which vibrations are maintained, and the like.

Additionally, in this process, weight of objects piled in the cart robot 100 may be stored as feature data. Vibrations that are sensed when the cart robot 100 piled with a heavy load moves on a road surface may differ from vibrations that are sensed when the cart robot 100 piled with a light load moves on a road surface.

While moving, the plurality of cart robots 100 record vibrations of the road surface, which are respectively sensed by the cart robots, as data. The recorded data may be stored in the cart robots 100 or may be transmitted to an external server.

Additionally, a load cell 245 may be implemented as an example of the vibration sensor 260. The load cell 245 constitutes the force sensor 240 and senses forces applied to the handle assembly 120. The load cell 245 may measure vibrations that are caused by friction of the cart robot 100 against the road surfaces of LAND1 and LAND2, which have different characteristics, while the cart robot 100 is moving.

Accordingly, the cart robot 100 collects signals of the load cell 245 while moving on various road surfaces such as the road surfaces of a parking lot, a retail store, and the like to classify spaces in which the cart robot 100 moves. Further, a device such as a server and the like that provide the function of learning, or the cart robot 100 extract features of each of the road surfaces (the road surface of a retail store and the road surface of a parking lot) and perform machine learning.

The cart robot 100 may classify spaces such as a retail store, a parking lot and the like having different states of road surfaces in real time, using parameters learned through machine learning and using values sensed by the vibration sensor 260 while the cart robot 100 is moving.

Additionally, the cart robot 100, the server and the like may periodically update learning parameters through edge learning.

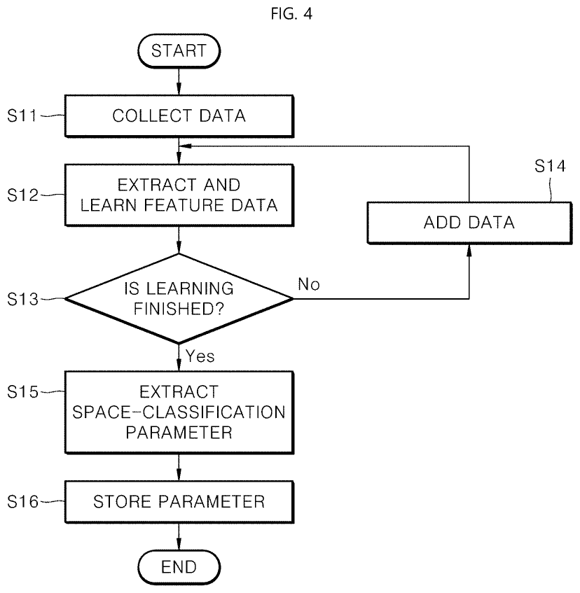

FIG. 4 shows a process in which a cart robot according to an embodiment performs learning on collected data.

Features are extracted from data collected by the cart robots 100 through predetermined learning. Each of the cart robots 100, as illustrated in FIG. 3, collects data while moving (S11).

Additionally, the collected data are accumulated and stored. A learning module constituting the server 500 or the cart robot 100 extracts feature data and performs learning, using stored data (S12).

While learning is performed, the server or the cart robot 100 confirms whether the learning is completed (S13). When the learning is not completed, the server or the cart robot 100 adds data again (S14). The addition of data includes using pre-stored data or performing step 11 by the cart robot 100.

When data are sufficiently accumulated and learning is completed, the server or the cart robot 100 extracts space-classification parameters (S15), and the cart robot 100 stores the parameters (S16). The cart robot 100 may confirm the state and location of a road surface using the parameters when vibrations are caused due to the road surface later, on the basis of the stored results.

Each cart robot 100 may perform learning on the steps in FIG. 4, or a plurality of cart robots 100 collect data and an additional server may perform learning.

When the vibration sensor 260 is a load cell, feature data required for classifying spaces include the covariance, spectral entropy, force and the like of signals generated through the sensing of vibrations by the load cell 245. However, the present disclosure is not limited to what has been described.

When the vibration sensor 260 is an IMU sensor 247, feature data required for classifying spaces include the correlation, variance, entropy, signal difference and the like of signals generated through the sensing of vibrations by the IMU sensor 247. However, the present disclosure is not limited to what has been described.

The process in FIG. 4 is described as follows.

A vibration sensor 260 senses vibrations that are generated while a cart robot 100 is moving (S22), and a control unit 250 extracts feature data from data sensed by the vibration sensor 260 (S23). Additionally, the control unit 250 compares the feature data and parameters, and identifies a space in which the cart robot 100 is moving (S25 to S27). Identifying a space during moving means classifying spaces such as LAND1, LAND2 and the like.

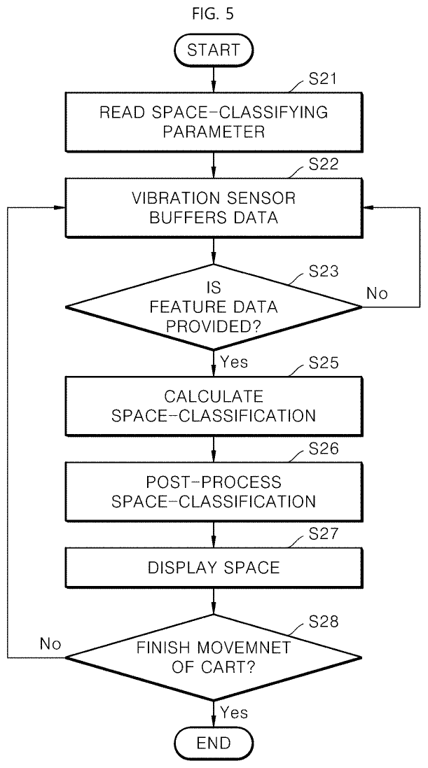

FIG. 5 shows a process in which a cart robot according to an embodiment classifies spaces.

The cart robot 100 stores space-classification parameters extracted in FIG. 4 and then reads the parameters while moving (S21). Additionally, the vibration sensor buffers data that are sensed while the cart robot is moving (S22). Buffering data denotes temporarily storing data sensed by the vibration sensor.

The buffered data are delivered to the control unit 250, or values sensed by the vibration sensor 260 may be transmitted to the control unit 250 in real time without buffering. That is, the vibration sensor 260 is a primary subject performing buffering, and the control unit 250 is a final subject performing buffering. The control unit 250 may buffer, accumulate and store data that are sensed by the vibration sensor 260 while the cart robot is moving.

The control unit 250 extracts feature data from buffered data (accumulated and stored data) and confirms whether there are sufficient feature data (S23). If there aren't sufficient feature data, the vibration sensor 260 collects more data (S22).

When there are sufficient feature data, the control unit 250 calculates the classifying of a space using the above-described space-classification parameters (S25). Additionally, the control unit 250 performs post-processing of results of calculation on the basis of the classifying of a space (S26), and then displays the space in an interface unit 230 (S27). Further, the processes of S22 to S28 will be repeated until the cart robot 100 finishes moving (S28).

The cart robot 100 may store control information on a moving unit 190, which is applicable to an identified space. Additionally, when an error occurs while the cart robot 100 is moving after applying the control information on the moving unit 190 in the identified space, the cart robot 100 may store information on the error and may change the parameters or a learning module 300.

For example, more vibrations may be generated or an obstacle inappropriate for LAND1 (a plurality of obstacles sensed in LAND2) may be sensed during the process in which the cart robot 100 is moving after the moving unit is controlled to fit for LAND1 on the basis of feature data that are classified to identify a space as LAND1. In this case, the cart robot 100 may re-classify the feature data that are previously classified such that the space may be classified as LAND2.

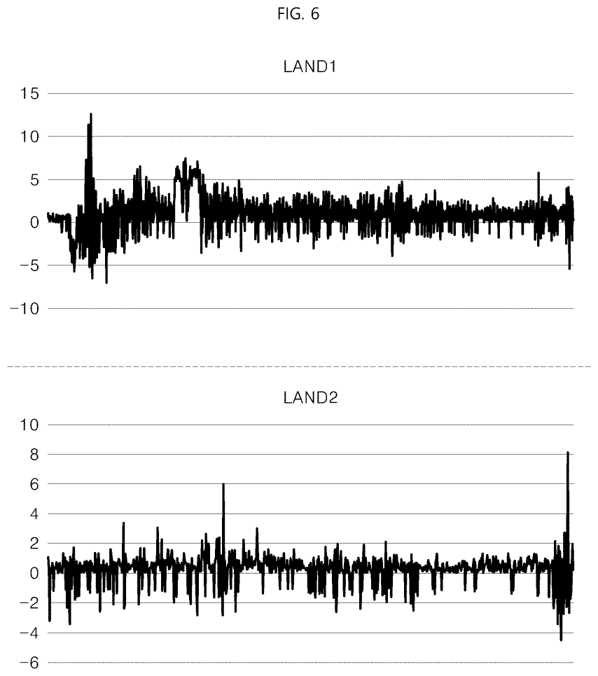

FIG. 6 shows signals sensed by a vibration sensor in LAND1/LAND2 according to an embodiment. FIG. 6 shows values sensed by the vibration sensor while the cart robot 100 is moving in LAND1 and LAND2.

Signals in FIG. 6 are accumulated while the cart robot 100 is moving. The cart robot 100 may further store information on whether the space, in which the cart robot is currently moving, is LAND1 or LAND2, or may accumulate and store only signals without the above-described information on space.

Additionally, the cart robot 100 may store weight of a stored object by sensing weight of a storage part 110, together with values sensed by the vibration sensor.

A plurality of cart robots 100 collect values sensed and generated by the vibration sensor. Additionally, any one of the cart robot 100 and the server may perform learning on the data. When a feature map is generated as a result of learning on the basis of the collected data, a function of a classification line that distinguishes values sensed in LAND1 and LAND2 respectively by the vibration sensor is calculated.

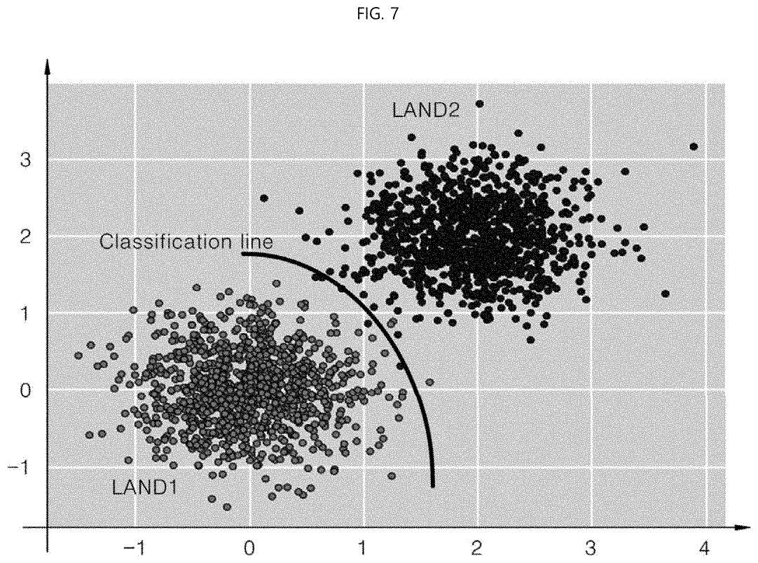

Next, when the cart robot 100 applies values, sensed by the vibration sensor, to the feature map in FIG. 7 using the above-described function or to the above-described function, the cart robot 100 may confirm whether the cart robot 100 is currently moving in LAND1 or in LAND2 on the basis of the values sensed by the vibration sensor.

FIG. 7 shows a feature map that displays values sensed by a vibration sensor according to an embodiment.

The feature map in FIG. 7 may be generated by each sensor when there are two or more vibration sensors. When a load cell 245 is the vibration sensor, the cart robot 100 or the server may generate a load cell feature map.

When an IMU sensor 247 is the vibration sensor, the cart robot 100 or the server may generate an IMU sensor feature map.

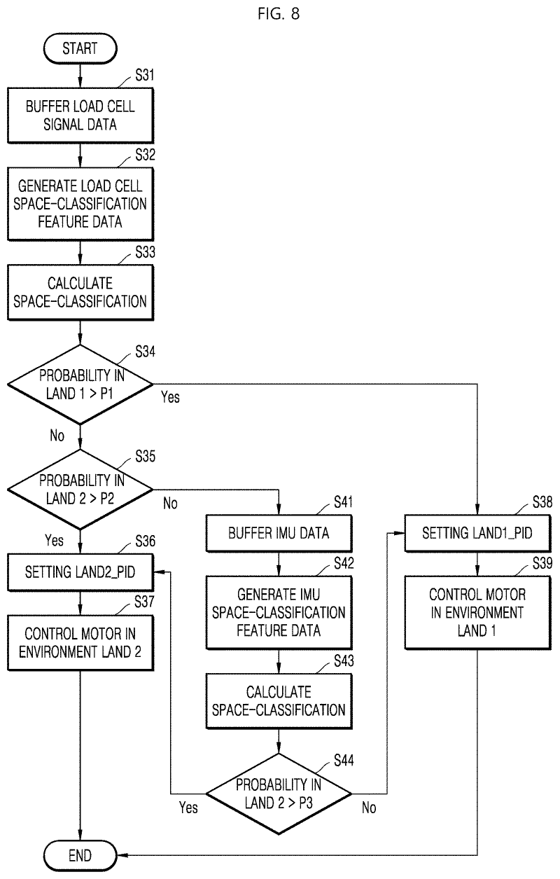

FIG. 8 shows a process in which a cart robot according to an embodiment controls movements of the cart robot using signals of a load cell and an IMU sensor. The process in which the cart robot 100 distinguishes two spaces using the load cell 245 and the IMU sensor 247 is described as follows.

For example, the load cell 245 operates as a first vibration sensor, and the IMU sensor 247 operates as a second vibration sensor. Additionally, the control unit 250 buffers signals of the first vibration sensor and generates first feature data. Then when unable to identify a space in which the cart robot is moving (No in S35), the control unit 250 buffers signals of the second vibration sensor and generates second feature data, and then may identify the space in which the cart robot is moving.

The cart robot 100 moves in the space of LAND1 having a relatively smooth road surface and the space of LAND2 having a relatively rough road surface. An example of LAND1 may be a store such as a large-scale retail store, and an example of LAND2 may be a parking lot.

First, the cart robot 100 buffers signals generated by a load cell 245 as data (S31). The control unit 250 generates feature data required for classifying spaces using the signals generated by the load cell 245 (S32). Then the control unit 250 calculates the space classification (S33). The control unit 250 applies the feature data in S32 to the feature map in FIG. 7.

As a result, the control unit 250 confirms whether the probability that the cart robot is currently moving in LAND1 is greater than P1 (S34). P1 may be set differently. An example of P1 is a percentage such as 80%, 90% and the like.

When the probability that the cart robot is currently moving in LAND1 is greater than P1 in step 34, the control unit 250 controls the motor of the moving unit 190 such that the cart robot may fit to move in identified LAND1. For example, the control unit 250 sets PID of the motor to PID of a motor (LAND1_PID) fit for LAND1 (S38).

Additionally, the control unit 250 controls the motor according to the set value (LAND1_PID) when the cart robot 100 moves in LAND1 (S39). The control unit 250 may adjust (proportional, integral, derivative) PID of the motor supplying electric energy to the moving unit 190 on the basis of results of identifying a space.

This is only an example. In addition, the control unit 250 may control the moving unit 190 such that the cart robot may fit to move on an identified road surface (LAND1). Additionally, the control unit 250 may adjust the force sensed by the force sensor 240 and the speed of the moving unit 190 such that the force and the speed may fit for LAND1.

When the probability that the cart robot is currently moving in LAND1 is less than P1 in step 34, the control unit 250 confirms whether the probability that the cart robot is moving in LAND2 is greater than P2 (S35). P2 may also be set differently. An example of P2 is a percentage such as 80%, 90% and the like.

When the probability that the cart robot is moving in LAND2 is greater than P2 in step 35, the control unit 250 controls the motor of the moving unit 190 such that the cart robot may fit to move in LAND2. For example, the control unit 250 sets PID of the motor to PID of a motor (LAND2 PID) fit for LAND2 (S36).

Additionally, the control unit 250 controls the motor according to the set value (LAND2_PID) when the cart robot 100 moves in LAND2 (S37). In addition, the control unit 250 may control the moving unit 190 such that the cart robot may fit to move on an identified road surface (LAND2). Further, the control unit 250 may adjust the force sensed by the force sensor 240 and the speed of the moving unit 190 such that the force and the speed may fit for LAND2.

When the probability that the cart robot is moving in LAND2 is less than P2 in step 35, the control unit 250 may distinguish spaces using the IMU sensor 247 because it is difficult for the control unit 250 to confirm a space only through sensing result of the load cell 245.

The control unit 250 buffers data sensed by the IMU sensor 247 (S41), or the data may be accumulated in step 31. Additionally, the control unit 250 generates IMU-space-classification feature data (S42), and calculates space classification (S43). The control unit 250 applies the feature data to the feature map in FIG. 7.

As a result, the control unit 250 confirms whether the probability that the cart robot is currently moving in LAND2 is greater than P2 (S44). P3 may be set differently.

On the basis of results of confirmation, the control unit 250 proceeds with step 36 or step 38.

FIG. 8 shows a process in which an IMU sensor is used when the control unit 250 may not classify spaces using values sensed by a single load cell. In the case in which the control unit 250 uses only a load cell, the control unit 250 may proceed with step 31 when the answer is No in step 35.

When the control unit 250 classifies spaces in which the cart robot 100 is moving using the vibration sensor and tunes PID values of the motor constituting the moving unit 190 according to characteristics of the classified space, the performance of movements of the cart may be enhanced.

In FIG. 8, the control unit 250 may adjust PID values, and the moving unit 190 such that the cart robot may fit for an identified space. For example, the control unit 250 may control directions or speeds of movements of the moving unit 190 such that the cart robot may fit for an identified space. Additionally, the control unit 250 may change magnitude of electric energy supplied to the moving unit 190. The control unit 250 may reflect characteristics of the road surfaces of identified spaces such as LAND1/LAND2 and the like, characteristics of objects disposed in spaces, and the like.

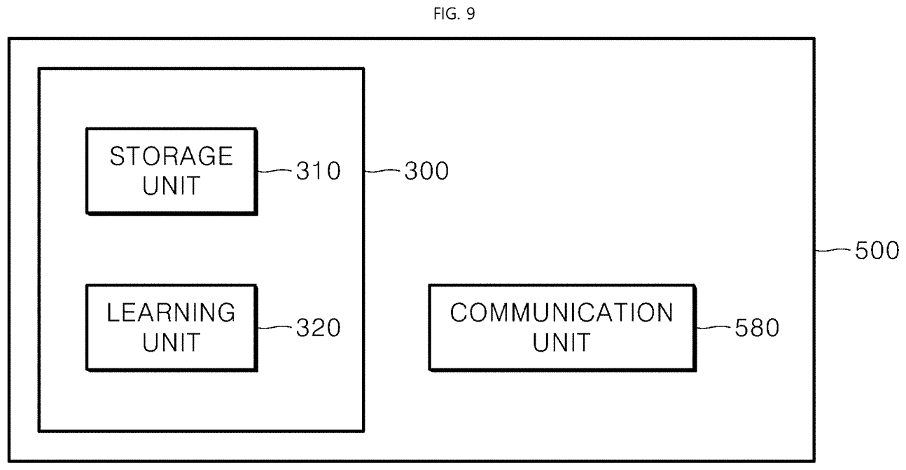

FIG. 9 shows a configuration of a server according to an embodiment.

The server 500 includes a learning module 300 and a communication unit 580. The learning module 300 may be mounted onto the control unit 250 of the cart robot 100. That is, the learning module 300 in FIG. 9 is mounted onto the cart robot 100 when the cart robot 100 performs learning. The learning module 300 may be a subordinate component of the control unit 250.

A storage unit 310 of the learning module 300 stores first data that are sensed by the vibration sensor 260 of the cart robot 100 while the cart robot is moving in a first space, and second data that are sensed by the vibration sensor 260 of the cart robot 100 while the cart robot 100 is moving in a second space.

Additionally, a learning unit 320 classifies a plurality of first data and a plurality of second data that are stored in the storage unit, and generates parameters that identify the plurality of first data as the first space and the plurality of second data as the second space.

The learning unit 320 may implement the line (classification line) that classifies two spaces in FIG. 7 as parameters.

That is, the learning unit 320 converts the first data into feature data corresponding to LAND 1 on the x-axis/the y-axis. Additionally, the learning unit 320 converts the second data into feature data corresponding to LAND 2 on the x-axis/the y-axis. Further, the learning unit 320 generates parameters that define a predetermined line, a two-dimensional curve, a three-dimensional curve and the like which distinguish spaces mapped between LAND1 and LAND2.

The learning unit 320 may generate feature data corresponding to the x-axis/the y-axis/the z-axis from signals generated by each sensor, or may generate time data as feature data.

As an example, signals sensed by the vibration sensor are converted into N-dimension as feature data of the first data and the second data.

For example, the first data includes speeds of movements of the cart robot in the first space. Additionally, the first data includes the size of amplitude sensed by the vibration sensor of the cart robot in the first space or magnitude of time during which amplitude is maintained.

For example, the second data includes speeds of movements of the cart robot in the second space. Additionally, the second data includes the size of amplitude sensed by the vibration sensor of the cart robot in the second space or magnitude of time during which amplitude is maintained.

The learning unit 320 may perform learning using meta information on whether the first data and the second data are generated respectively in the first space and the second space, or may perform learning without meta information on whether the first data and the second data are generated respectively in the first space and the second space.

As a result of learning, the learning unit 320 generates parameters that classify data of the two areas, i.e., parameters that indicate a boundary line between data of the two areas.

The communication unit 580 receives the first data and the second data from a plurality of cart robots, and transmits the parameters generated by the learning unit 320 to the plurality of cart robots.

In summary, the learning module 300 in FIG. 9 extracts data sensed by the vibration sensor as feature data, and generates space-classification parameters that map the data on any one space among two or more spaces. Additionally, the learning module 300 is included in the server 500 or the control unit 250.

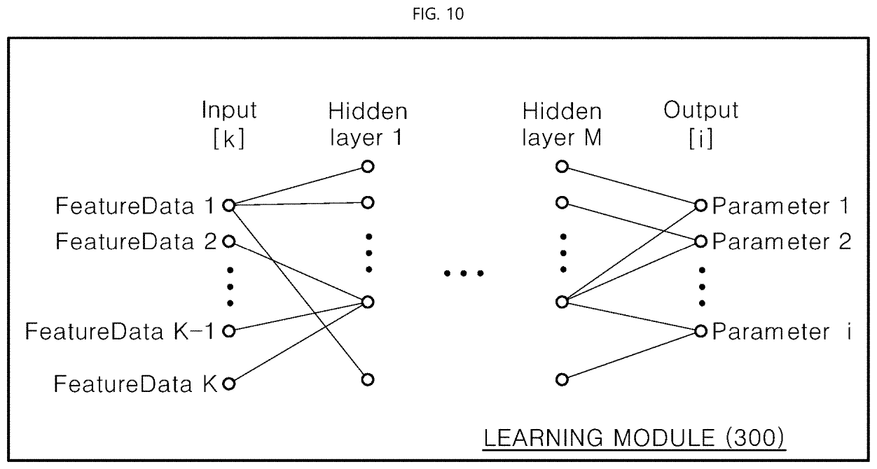

FIG. 10 shows a configuration of a learning module according to an embodiment.

The control unit 250 of the cart robot 100 may further include a learning module 300, or the server 500, as in FIG. 9, may include a learning module 300.

When the vibration sensor 260 provides sensed values to the control unit 250 or the server 500, the learning module 300 in the control unit 250 or the server 500 receives the sensed values and generates parameters required for identifying a space.

As an example, the learning module 300 is machine learning or a deep learning network.

The control unit 250 of the cart robot or the server 500 may perform context-awareness using the learning module. Likewise, the control unit 250 or the server 500 may identify a space, in which the cart robot 100 is moving, using sensed values, control by a user, or information received from other cart robots or the server, and the like as input values of the learning module.

The above-described learning module 300 may include an inference engine, a neural network, and a probability model. Additionally, the learning module 300 may perform supervised learning or unsupervised learning on the basis of various data.

Further, the learning module 300 may exemplarily perform natural language processing to recognize the voice of a user and to extract information from the voice.

As in FIG. 10, the learning module 300 may include a deep learning network to identify a space using vibrations on a road surface. As an example, input feature data are data sensed by the vibration sensor or converted from the data sensed by the vibration sensor. Additionally, feature data includes information on weight of objects piled in the storage box of the cart robot 100, and includes information speeds of the cart robot 100.

That is, information on the total weight (or mass) of the cart robot, on the speed of the cart robot, on the autonomous driving mode or the semi-autonomous driving mode of the cart robot, which may affect the generation of vibrations and a change of vibrations, are all input as feature data. Additionally, the learning module 300 generates parameters appropriate to identify a space, using various feature data that are input.

As an example, learning may be performed on the basis of resetting of layers of the deep learning network in the learning module instead of generating parameters. When information is given to each space according to supervised learning, the learning module 300 input feature data to an input layer and designates space-classifying information (0, 1, 2 and the like) to adjust a hidden layer for output.

Parameters are stored in the control unit 250. Next, the control unit 250 converts data, acquired and sensed by the vibration sensor 260 while the cart robot 100 is moving, and then compares the converted data and the parameters or inputs the converted data to the learning module 300, to identify a driving space.

In this process, the control unit 250 generates information on weight, speed, time and the like as feature data in addition to the data sensed by the vibration sensor 260, to enhance accuracy in identifying a space.

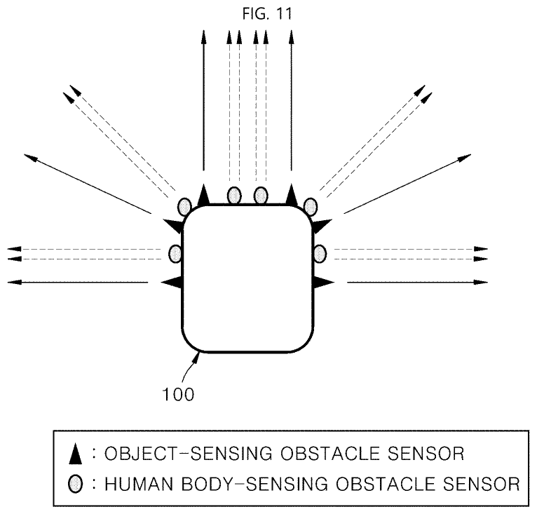

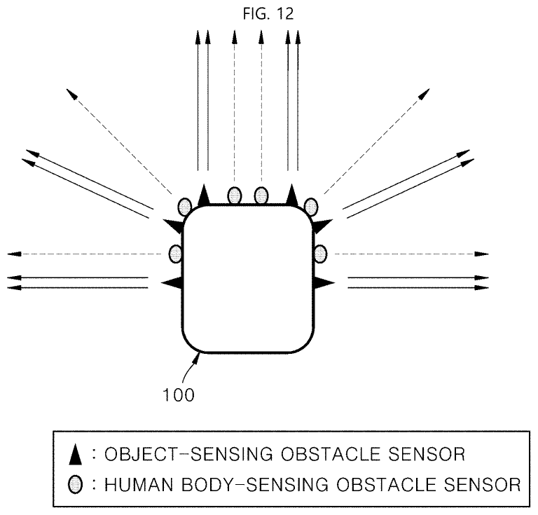

FIGS. 11 and 12 show a configuration in which sensing features of an obstacle sensor according to an embodiment are adjusted.

In the above-described embodiment, when a space in which the cart robot 100 is currently moving is identified, a sensing distance, a sensing period and the like of the obstacle sensors 220 may be adjusted to fit for the space.

For example, when identifying a retail store as a space, the cart robot 100 may control a sensing period or a sensing distance of the obstacles sensors 220 to exactly sense the human body, thereby preventing the cart robot 100 from bumping against people.

As illustrated in FIG. 11, human body-sensing obstacle sensors perform sensing two times during a period in which object-sensing obstacle sensors perform sensing once, among obstacle sensors. Accordingly, accuracy in sensing human bodies may be enhanced. The control unit 250 controls obstacle sensors to fit for the retail store that is an identified space such that the obstacle sensors may accurately sense human bodies.

When identifying a parking lot as a space, the cart robot 100 may control a sensing period or a sensing distance of obstacle sensors 220 to accurately sense vehicles, thereby preventing the cart robot 100 from bumping against vehicles.

As illustrated in FIG. 12, object-sensing obstacle sensors perform sensing two times during a period in which human body-sensing obstacle sensors perform sensing once, among obstacle sensors. Accordingly, accuracy in sensing automobiles may be enhanced. The control unit 250 controls obstacle sensors to fit for the parking lot that is an identified space such that the obstacle sensors may accurately sense objects.

According to an embodiment, the cart robot 100 in an autonomous driving mode (following mode) in which the cart robot moves along a moving path of a user moves on the basis of different characteristics of spaces such as the inside of a retail store and a parking lot.

The cart robot 100 may focus on sensing pedestrians when moving autonomously in a retail store. Additionally, the cart robot 100 may focus on sensing vehicles when moving autonomously in a parking lot. Accordingly, the control unit 250 may control a method for sensing obstacles by the cart robot 100.

Further, the cart robot 100 may vary magnitude of electric energy supplied to the moving unit 190 in response to pushing or pulling forces applied by a user even in a semi-autonomous driving mode (power-assist mode) depending on spaces. Specifically, a cart robot 100 provided with semi-autonomous driving may use a load cell, which is disposed in the handle assembly and is one of the force sensors, to distinguish spaces, and may provide economic and technical advantages in collecting various pieces of information using a load cell as a single sensor.

The cart robot 100 moving in a space such as a retail store/parking lot and the like having different road surfaces accumulates loads (piled objects) applied to a cart during the process in which the cart robot moves from the retail store to the parking lot. This requires changes in control over electric currents of the motor when necessary.

Accordingly, the cart robot 100 applies tuned PID values optimal for a road surface (e.g., floors of a parking lot and a retail store) of a space to the motor of the moving unit 190 to maintain driving performance, specifically, a following mode at the time of autonomous driving or a power-assist mode at the time of semi-autonomous driving.

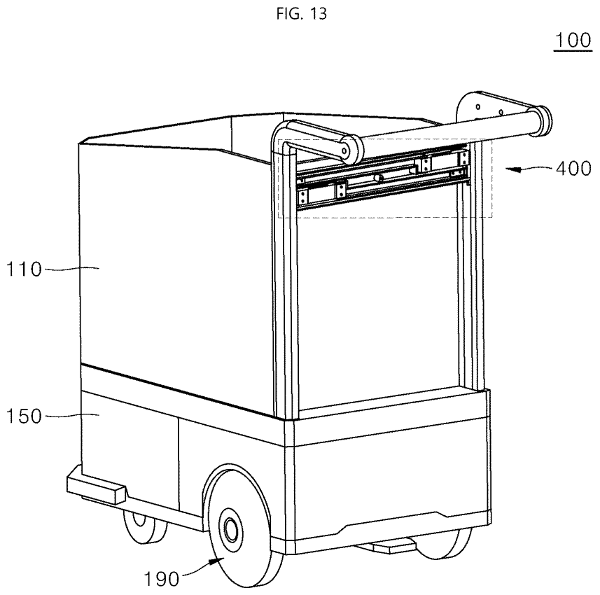

Hereinafter, a configuration in which a load cell as an example of a vibration sensor is disposed is specifically described. The configurations of FIGS. 13 to 17 in which a load cell 442, 442′ is disposed may vary according to a configuration of a cart robot 100.

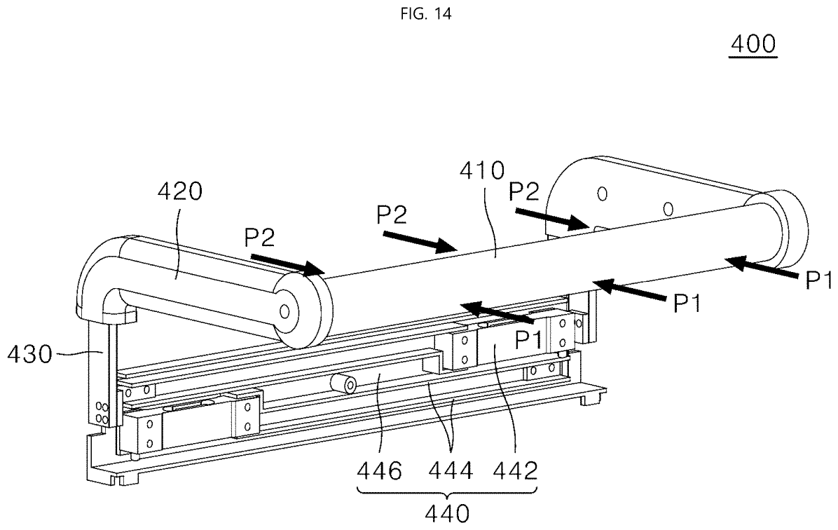

FIG. 13 shows a rear of the cart robot 100 in FIG. 1 as an embodiment, and FIG. 14 shows an enlarged handle assembly.

A handle bar 410 of the handle assembly 400 is a straight bar, and a plurality of frames form the appearance of the handle bar 410. An accommodating space may be formed in the handle bar 410 by the frames. A force sensor 440 may be placed in the accommodating space, and some of the components of the force sensor 440 may be exposed outside the handle bar 410.

P1 in FIG. 14 is a direction of force applied by a user to a cart 100 such that the user moves forward, and P2 is a direction of force applied by a user to a cart 100 such that the user move backward. When a user moves forward, the user pushes the cart 100 in direction P1, and when the user moves backward, the user pulls the cart 100 in direction P2. The directions of force are sensed through a force sensing module 440 and delivered to a control unit 250 to provide the function of power-assist.

As illustrated in FIG. 14, a handle cover frame 420 supports the straight handle bar 410 at both ends of the handle bar 410. To this end, a pair of handle cover frames 420 are provided. One end of each of the handle cover frames 420 is coupled to one end of the handle bar 410, and the other end of each of the handle cover frames 420 is bent downward in a streamlined shape. The handle cover frame 420 has an accommodating space therein according to the shape of the handle cover frame 420. A handle support frame 430 is inserted into the accommodating space

The handle support frame 430 is a skeleton of the handle assembly 400. The handle support frame 430 is inserted into each of the handle cover frames 420. Accordingly, a pair of handle support frames 430 are provided.

The handle bar 410 or the handle cover frame 420 may be comprised of a material except metal, but the handle support frame 430 may be comprised of metal or a material with rigidity. The handle support frame 430 supports force (external force) applied to the handle bar 410 and delivers the external force to the force sensor 440. To this end, the handle support frame 430 is connected with the force sensing module 440. To be precise, the handle support frame 430 is coupled to a connection bracket 444 of the force sensing module 440.

The force sensor 440 may be disposed at an upper end of the rear surface of a main body 100 in the lower side of the handle support frame 430. The force sensor 400 may be disposed at the rear of a storage part 110 and may be coupled onto the storage part 110 or may be coupled onto an additional frame supporting the storage part 110. The force sensor 440 includes a load cell 442 that senses directions of force applied to the handle bar 410, a connection bracket 444 on which the force sensor 442 is mounted, and a support frame 446.

The load cell 442 is a sensor for measuring directions of external force that is a force applied by a user to the handle bar 410. In addition to the load cell 442, sensors capable of sensing directions of force may constitute the force sensor 440.

The load cell 442 may also sense vibrations of a road surface. According to an embodiment, a load cell 442 may be placed in the handle assembly 400 to provide the functions as a vibration sensor 260 and a force sensor 440.

A load cell is a weight sensor using an elastic material proportionally deformed by external force, and a strain gage converts a degree of deformation of an elastic material into electric signals. When mass is applied to an elastic material, elastic movements occur, and a change in resistance in response to applied mass in a strain gage occurs. Changes in weight may be sensed by converting a change in resistance into electric signals in an electric circuit.

Load cells may be classified as a bar type capable of measuring pulling or pushing forces, a cylinder type capable of measuring pressing forces, an S type capable of measuring pulling forces, and the like, according to their shapes.

In FIG. 14, a bar-type load cell 442 is used to measure directions of pulling or pushing forces applied to the handle bar 410 as a force sensor 440. When the handle bar 410 is pushed in direction P1 or P2 to move the cart 100 forward or backward, force delivered to the handle support frame 430 is delivered to the load cell 442 through the connection bracket 444. A sensing value of the load cell 442 may vary according to directions of the force delivered to the load cell 442. Accordingly, the control unit 250 may determine a direction of force applied to the handle bar 410.

Additionally, the load cell 442 senses vibrations delivered to the handle. The vibrations are sensed while the cart robot 100 is moving on a road surface, data on sensed vibrations are delivered to the control unit 250, and the control unit 250 identifies a space having the road surface on which the cart robot 100 is currently moving.

A pair of load cells 442 are provided to sense external forces delivered through a pair of handle support frames 430. The load cell 442 has a bar shape. Accordingly, one end of the load cell 442 is coupled to the connection bracket 444 and the other end is coupled onto the support frame 446. One end of the load cell 442, coupled to the connection bracket 444, is a free end, and the other end, coupled to the support frame 446, is a fixed end.

Accordingly, when forces are applied to the connection bracket 444, the free end of the load cell 442 is deformed. Resistance values of the force sensor 442 may differ through the deformation of the free end. Thus, directions of external forces may be determined.

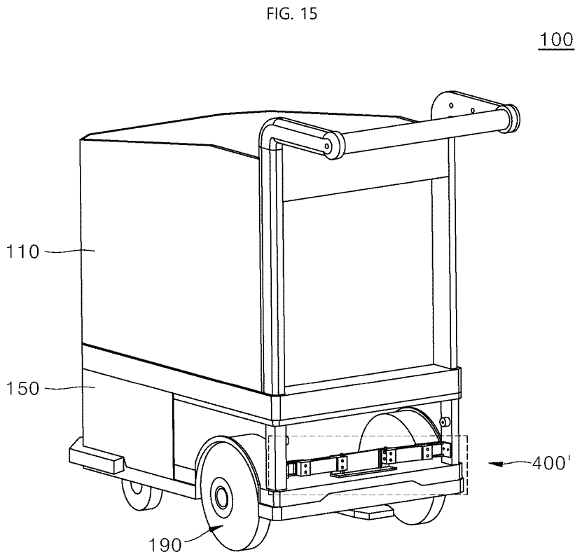

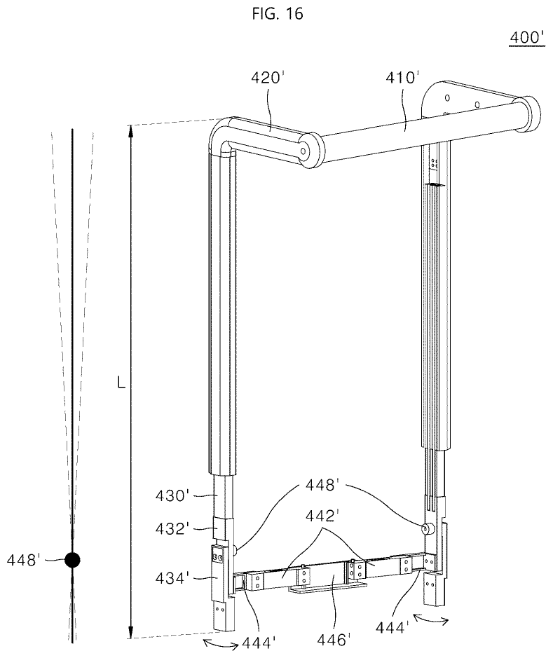

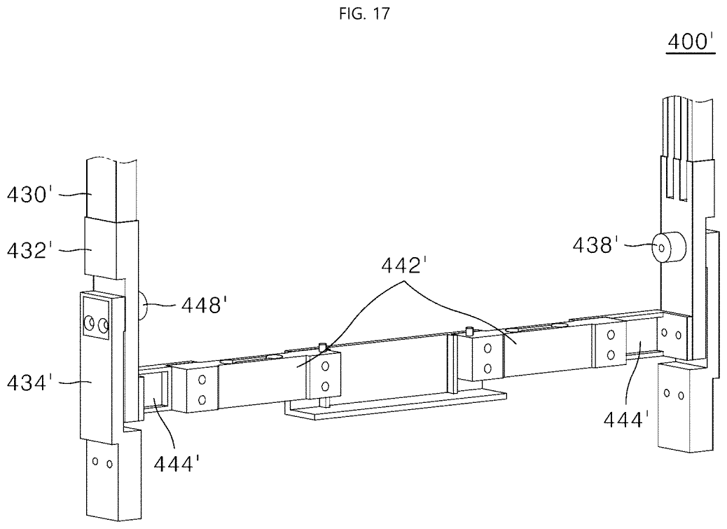

FIG. 15 shows a rear perspective view of a rear of cart according to another embodiment, and FIGS. 16 and 17 show enlarged main parts of the handle assembly in FIG. 15.

The handle assembly 400′ may be provided with a force sensor 440′ in the lower portion of the cart 100. The handle assembly 400′ includes a pair of handle support frames 430′. Additionally, the handle assembly 400′ includes a pair of first sub frames 432′, a pair of second sub frames 434′, and a force sensor 440′ connected to the second sub frames 434′.

As illustrated in FIGS. 15 to 17, a handle cover frame 420′ extends up to the lower portion of the cart robot 100, and the handle support frames 430′are inserted into the handle cover frame 420′. One end of the handle cover frame 420′ is coupled to a handle bar 410, and the other is bent and extended downward. The upper side of the handle cover frame 420′ in the length-wise direction thereof (L) may be coupled to a main body 100′. That is, the handle cover frame 420′ may be coupled to the main body 100′ such that the handle cover frame 420′ may be elastic enough to deliver forces applied in direction P1 or P2 to the handle support frames 430′ with respect to the portion of the handle cover frame 420′ coupled to the main body 100′.

The handle support frame 430′ is a straight bar that is disposed in the length-wise direction (L). A part of the lower end of the handle support frame 430′ is exposed outside the handle cover frame 420′. However, the handle support frame 430′ is not exposed outside the main body because the handle support frame 430′ is stored inside the main body. The first sub frame 432′ and the second sub frame 434′ are coupled to the lower end of the handle support frame 430′.

One end of the first sub frame 432′ is coupled to the lower end of the handle support frame 430′, and the other end extends downward. The second sub frame 434′ and a hinge unit 448′ are coupled to the upper side of the downward extended portion of the first sub frame 432′. The portion is defined as a hinge coupling portion 432a′. Additionally, a load cell 442′ is coupled to the lower end of the downward extended portion of the first sub frame 432′ by the connection bracket 444.

The second sub frame 434′ is rotatably coupled to the first sub frame 432′ by the hinge unit 448′. The upper end of the second sub frame 434′ is coupled to the first sub frame 432′ by the hinge unit 448′, and the other end extends downward. The other end may be stored and fixed inside the main body 100′. The upper end is defined as a hinge coupling portion 434a′.

The portion with each of the hinge coupling portions 432a′, 434a′ may be thinner than the portion without the hinge coupling portions 432a′, 434a′ such that the portion in which the first sub frame 432′ and the second sub frame 434′ are coupled may not be thicker than the handle support frame 430′.

Additionally, the second sub frame 434′ may be directly coupled to the lower end of the handle support frame 430′ without additionally including the first sub frame 432′.

A force sensor 440′ includes a load cell 442′, a connection bracket 444′ that connects the load cell 442′ and the first sub frame 432′, and a support frame 446 that supports the load cell 442′. A pair of load cells 442′ and a pair of connection brackets 444′ may be provided, and a single support frame 446′ may be provided.

The connection bracket 444′ connects the force sensor 442′ and the first sub frame 432′. A sensor mounting unit 444a is formed at one end of the connection bracket 444′ such that the force sensor 442′ may be coupled by a bolt and the like. A frame coupling unit 444b is formed at the other end of the connection bracket 444′ such that the first sub frame 432′ is coupled by a bolt and the like.

The force sensing and power assist of a cart with the above-described configuration according to an embodiment is described.

The lower end of the second sub frame 434′ is fixed onto the cart robot 100 but the upper end is not fixed. Accordingly, the upper end is more movable than the lower end.

The upper end of the first sub frame 432′ is coupled to the handle support frame 430′, and the lower end of the first sub frame 432′ is rotatably coupled to the second sub frame 434′ and is not fixed to the cart robot 100. Accordingly, the lower end of the second sub frame 434′ may rotate in the directions of the arrows in FIG. 16 with respect to the hinge unit 448′.

The handle support frame 430′ is inserted into the handle cover frame 420′, and the other end of the handle support frame 430′ is coupled to the first sub frame 432′. Accordingly, the upper end of the handle support frame 430′ may be slightly movable with respect to the hinge unit 448′ (dotted line in direction L in FIG. 16 indicating displacement of the handle support frame).

Forces are applied to the handle bar 410 in direction P1 or P2 (see FIG. 14). When force is applied to the handle bar 410 in direction P1 or P2, the handle support frame 430′ and the first sub frame 432′ move in the direction of the arrow with respect to the hinge unit 448′ (see direction of the arrow in FIG. 16).

Although in embodiments, all the elements that constitute the embodiments of the present disclosure are described as being coupled to one or as being coupled to one so as to operate, the disclosure is not limited to the embodiments. One or more of all the elements may be optionally coupled to operate within the scope of the present disclosure. Additionally, each of the elements may be implemented as single independent hardware, or some or all of the elements may be optionally combined and implemented as a computer program that includes a program module for performing some or all of the combined functions in single hardware or a plurality of hardware. Codes or segments that constitute the computer program may be readily inferred by one having ordinary skill in the art. The computer program is recorded on computer-readable media and read and executed by a computer to implement the embodiments. Storage media that store computer programs includes storage media magnetic recording media, optical recording media, and semiconductor recording devices. Additionally, the computer program that embodies the embodiments includes a program module that is transmitted in real time through an external device.

The embodiments of the present disclosure have been described. However, the embodiments may be changed and modified in different forms by one having ordinary skill in the art. Thus, it should be understood that the changes and modifications are also included within the scope of the present disclosure.

1. A robot, which identifies a driving space using artificial intelligence, comprising;
a moving unit configured to move the robot;
a vibration sensor configured to sense vibrations generated while the robot is moving; and
a control unit configured to identify a space in which the robot is moving by extracting feature data from data sensed by the vibration sensor and by comparing the feature data and parameters, and configured to control directions or speeds of movements of the moving unit to fit for the identified space, or configured to change magnitude of electric energy supplied to the moving unit.

2. The robot of claim 1, wherein the robot further includes a force sensor configured to sense a change in forces applied to a handle assembly of the robot,
the vibration sensor is a load cell constituting the force sensor.

3. The robot of claim 1, wherein the control unit adjusts PID values of a motor supplying electric energy to the moving unit on the basis of results of identifying the space.

4. The robot of claim 1, wherein the control unit buffers data sensed by the vibration sensor while the robot is moving, and then extracts the feature data from the buffered data.

5. The robot of claim 1, wherein the vibration sensor includes a first vibration sensor including a load cell, and a second vibration sensor including an IMU sensor,
when the control unit may not identify a space in which the robot is moving after buffering signals of the first vibration sensor and generating first feature data,
the control unit identifies a space in which the robot is moving after buffering signals of the second vibration sensor and generating second feature data.

6. The robot of claim 1, wherein the robot further comprises a weight sensor configured to sense weight of objects piled in a storage part of the robot,
the control unit identifies the space using weight information sensed by the weight sensor.

7. The robot of claim 1, wherein the control unit further comprises a learning module configured to learn the extracted feature data,
the learning module generates space-classifying parameters configured to map the feature data on any one space among two or more spaces.

8. (canceled)

9. The robot of claim 1, wherein the robot further comprises an obstacle sensor configured to sense obstacles around the robot,
the control unit controls the obstacle sensor such that the obstacle sensor senses any one or more of an object or a human body more accurately to fit for the identified space.

10. A learning module, comprising:
a storage unit configured to store first data sensed by a vibration sensor of a robot while the robot is moving in a first space, and second data sensed by the vibration sensor of the robot while the robot is moving in a second space; and
a learning unit configured to generate parameters identifying a plurality of first data as the first space and identifying a plurality of second data as the second space by classifying the plurality of first data and the plurality of second data stored in the storage unit.

11. The learning module of claim 10, wherein the first data includes speeds of movements of the robot in the first space, and sizes of amplitude sensed by the vibration sensor of the robot or magnitude of time during which amplitude is maintained,
the second data includes speeds of movements of the robot in the second space, and sizes of amplitude sensed by the vibration sensor of the robot in the second space or magnitude of time during which amplitude is maintained,
the parameters indicate a boundary line between the plurality of first data and the plurality of second data.

12. The learning module of claim 10, wherein the first data and the second data includes weight information on objects piled in a storage part of the robot.

13. The learning module of claim 10, wherein the learning module is disposed in a server,
the server further comprises a communication unit configured to receive the first data and the second data from a plurality of robots.

14. A method of identifying a driving space using artificial intelligence by a robot, comprising:
moving a robot by a moving unit of the robot;
sensing vibrations generated while the robot is moving by a vibration sensor of the robot;
extracting feature data from data sensed by the vibration sensor by a control unit of the robot;
identifying a space in which the robot is moving by comparing the feature data and parameters by the control unit; and
controlling directions or speeds of movements of the moving unit to fit for the identified space by the control unit or changing magnitude of electric energy supplied to the moving unit by the control unit.

15. The method of claim 14, wherein the robot further includes a force sensor configured to sense a change in forces applied to a handle assembly of the robot,
the vibration sensor is a load cell constituting the force sensor.

16. The method of claim 14, wherein the method further comprises adjusting PID values of a motor supplying electric energy to the moving unit on the basis of results of identifying the space by the control unit.

17. The method of claim 14, further comprising:
buffering data sensed by the vibration sensor while the robot is moving by the control unit; and
extracting the feature data from the buffered data by the control unit.

18. The method of claim 14, wherein the vibration sensor includes a first vibration sensor including a load cell, and a second vibration sensor including an IMU sensor,
the method further comprises identifying a space in which the robot is moving after buffering signals of the second vibration sensor and generating second feature data by the control unit, when the control unit may not identify a space in which the robot is moving after buffering signals of the first vibration sensor and generating first feature data.

19. The method of claim 14, wherein the robot further comprises a weight sensor configured to sense weight of objects piled in a storage part of the robot,
the method further comprises identifying the space using weight information sensed by the weight sensor by the control unit.

20. The method of claim 14, wherein the control unit further comprises a learning module configured to learn the extracted feature data,
the method further comprises generating space-classifying parameters configured to map the feature data on any one space among two or more spaces by the learning module.

21. (canceled)

22. The method of claim 14, wherein the robot further comprises an obstacle sensor configured to sense obstacles around the robot,
the method further comprises controlling the obstacle sensor such that the obstacle sensor senses any one or more of an object or a person more accurately to fit for the identified space by the control unit.
